(19) United States
(12) Patent Application Publication
(10) Pub. No.: US 2014/0339163 A1
(43) Pub. Date: Nov. 20, 2014

(54) PERFORMANCE OF A MEMBRANE USED IN MEMBRANE DISTILLATION

(71) Applicants: Xianguo Yu, Shanghai (CN); Andrew Philip Shapiro, Niskayuna, NY (US); Rihua Xiong, Shanghai (CN); Hai Yang, Shanghai (CN); Hui Liu, ShangHai (CN)

(72) Inventors: Xianguo Yu, Shanghai (CN); Andrew Philip Shapiro, Niskayuna, NY (US); Rihua Xiong, Shanghai (CN); Hai Yang, Shanghai (CN); Hui Liu, ShangHai (CN)

(73) Assignee: GENERAL ELECTRIC COMPANY, Schenectady, NY (US)

(21) Appl. No.: 14/345,058

(22) PCT Filed: Sep. 16, 2011
(86) PCT No.: PCT/CN2011/001569

§ 371 Date: Mar. 14, 2014

(51) Int. Cl. B01D 71/26; B01D 65/08; B01D 61/36

(52) U.S. Cl. CPC B01D 71/26; B01D 61/364; B01D 61/368; B01D 65/08; B01D 2321/00
USPC 210/640; 210/500.21

(57) ABSTRACT

The present disclosure provides a method for improving the performance of a membrane for use in a membrane distillation process, and a membrane produced by the method. The method includes subjecting the membrane to a pressure difference across the membrane in order to open closed pores in the membrane.

### FIELD

The present disclosure relates generally to membrane contactors, and more specifically to membrane distillation.

### BACKGROUND

Membrane distillation is a method of purifying a feed liquid which uses a membrane as a barrier, and where a component of the feed liquid is transported across the membrane as a vapor. In this specification, membrane distillation will be discussed for convenience primarily with respect to hydrophobic membranes and purification of an aqueous solution, such as seawater, but membrane distillation can alternatively be used to purify hydrophobic liquids using a hydrophilic membrane.

In membrane distillation, the feed water contacts a feed side of a hydrophobic membrane and purified water, which may be referred to as permeate or distillate, contacts a permeate side of the hydrophobic membrane. Surface tension of the water prevents the feed water from entering the pores of the hydrophobic membrane. Instead, water molecules in the feed water evaporate to form water vapor, which is transported through pores in the hydrophobic membrane as a gas and condenses on the permeate side of the hydrophobic membrane, providing the permeate.

The transport of the water vapor across the hydrophobic membrane is driven by a difference in vapor pressure between the feed side and the permeate side of the hydrophobic membrane. The difference in vapor pressure is due to a temperature difference maintained between the feed water and the permeate.

Selectivity of transport across the hydrophobic membrane is determined by the vapour-liquid equilibrium, which is determined by the partial pressures of the components of the contaminated water source. Membrane distillation of a water/NaCl solution or seawater results in a high selectivity of water being transported across the membrane since the vapor pressure of NaCl and other salts is negligible. Given this, membrane distillation may be used, for example, in the desalination of sea water. However, such desalination is not practiced commercially to a significant extent at the present time.

Hydrophobic microporous membranes for use in membrane distillation can be prepared from hydrophobic polymers such as, for example, polyethylene (PE), polytetrafluoroethylene (PTFE), polypropylene (PP) or poly(vinylidene fluoride) (PVDF), or any other hydrophobic polymer that is able to prevent bulk liquid transport across the hydrophobic membrane. Hydrophobic membranes can, alternatively, be prepared from hydrophilic polymers which are transformed into hydrophobic membranes by, for example, radiation grafting polymerization or plasma polymerization.

It is generally desirable to improve the performance of a membrane distillation process by, for example: increasing the permeate flux (i.e. the flux of the permeate liquid across the membrane); increasing contaminant rejection; or, increasing operational stability. Permeate flux is dependent on factors such as: the temperature difference between the feed side and the permeate side, the material of the membrane, the pore structure, the porosity, and the membrane thickness.

### BRIEF DESCRIPTION OF THE INVENTION

Membrane distillation across a pore in the membrane requires that the pore not be wetted by either the feed water or permeate. The wettability of the pore is determined by the surface tension of the liquid and the surface energy of the membrane material which combine to create a contact angle between the liquid and membrane material. Decreasing the affinity between the membrane material and the liquid corresponds to increasing contact angle and decreasing wettability. Pores that do become wetted will reduce the flux and selectivity of the membrane since transport through the compromised pores will no longer be based on the vapour pressure differential across the pore.

Even with a contact angle of over 90 degrees, a pore in a hydrophobic material may still be wetted if water is applied to the membrane under sufficient pressure or if there are other effects involved, such as adsorption to contaminants. A large hole requires less applied pressure to be wetted. The normal operation of the distillation apparatus generates pressures in the feed water and the permeate, for example due to countercurrent flow of the feed liquid and permeate across opposite sides of the membrane, due to a transient pressure generated by opening a value, or due to pressure changes when a pump is started or stopped.

It is desirable to use membranes with high porosity (that is, the total area of all the pores divided by the total area of the membrane). However, it is difficult to manufacture a high porosity membrane with a pore size distribution that does not include some individual pores which are large enough to wet under some conditions. The pressures generated during operation of the distillation apparatus thus leads to pores becoming closed or semi-closed due to wetting over time and result in a diminished performance of the membrane over time.

Additionally, it has been found that membranes used in membrane distillation can have pores which are closed or semi-closed before the membrane is initially put in use. The pores may be closed or semi-closed to due liquids or solids becoming trapped in the pores during manufacture of the membrane, storage of the membrane, or both. Membrane manufacturing processes may include asymmetric stretching of the membrane. Such asymmetric stretching may induce polymer membrane crystallization and result in closed or semi-closed pores. Reduction in temperature during storage of the membrane may induce polymer membrane recrystallization and shrinking of the pores, thereby resulting in closed or semi-closed pores.

A method is described herein to open pores of a membrane used in membrane distillation. The method may be used before a membrane is put into use, or after a period of use. The method includes a step of applying a gas to one side of the membrane at a pressure higher than a gas or liquid on the other side of a membrane. For example, a membrane that has not been put in use may be exposed to a gas pressure differential in a fixture. For further example, a membrane distillation device may be drained on at least one side of the membrane, and compressed air may be applied to the drained side.

### BRIEF DESCRIPTION OF THE DRAWINGS

Examples of the present disclosure will now be described, by way of example only, with reference to the attached Figures.

FIG. 1A is a schematic illustrating an example of treating a membrane to open closed pores;

FIG. 1B is an illustration of a system for performing the method illustrated in FIG. 1B;

FIG. 2 is a schematic illustrating another example of treating a membrane to open closed pores;

FIG. 3 is a schematic illustrating a further example of treating a membrane to open closed pores

FIGS. 4A and 4B are graphs showing membrane distillation results for membranes treated under different conditions;

FIGS. 5A and 5B are graphs showing membrane distillation results for untreated membranes; and

FIGS. 6A and 6B are graphs showing membrane distillation results over time for a membrane treated at 15.6 psig.

### DETAILED DESCRIPTION

Generally, the present disclosure provides a method for improving the performance of a membrane used in a membrane distillation process. The method includes treating the membrane to a gas pressurized relative to a fluid on the other side of the membrane in order to open semi-closed or closed pores. It would be understood that, in the context of this description, closed and semi-closed pore refer to pores which were, at one point, open but are closed or partially closed due to, for example, a blockage in the pore, a shrinkage of the pore, or both. These closed and semi-closed pores can be opened using the described method. Pores having sides which are physically joined together during the manufacturing process are referred to as “real closed” pores and are not opened using the described method.

Treating the membrane to the relatively pressurized gas removes liquids, solids, or both liquids and solids trapped in the pores, thereby opening closed pores and increasing the total area of the pores available for membrane distillation. The increase in total area of the pores corresponds to an increase in the effective porosity and rejection of the membrane. The increased effective porosity results in increased flux during membrane distillation. Pores may be closed before the treatment due to liquids or solids trapped in the pores. The trapped liquids or solids may arise from the manufacture of the membrane, from membrane distillation conditions, or both.

During membrane distillation, the membrane may become less hydrophobic over time due to physical fouling of the surface of the membrane. Treating a hydrophobic membrane to the pressure difference removes liquids, solids or both from the surface of the membrane and may, therefore, also increase hydrophobicity of the membrane.

The membrane may or may not have been used in a membrane distillation process before being subjected to the contemplated method. For example, the membrane may be newly manufactured before being subjected to the contemplated method; or the membrane may have been used in a membrane distillation process for a period of time before being subjected to the contemplated method. Treating a newly manufactured membrane to the contemplated method may open pores which were closed due to the manufacture or storage of the membrane. Treating a membrane which was previously used in a membrane distillation process to the contemplated method may open pores which were closed due to the manufacture of the membrane, due to membrane distillation conditions, or both.

The pressure difference across the membrane may be generated by, for example: using a pressurized gas on one side of the membrane and a gas at atmospheric pressure on the other side of the membrane; using a gas at a reduced pressure on one side of the membrane and a gas at atmospheric pressure on the other side of the membrane; using pressurized gas on one side of the membrane and a gas at a reduced pressure on the other side of the membrane; or using a pressurized gas on one side of the membrane and a liquid at a lower pressure on the other side of the membrane. In the described situations, the pressure difference corresponds to the difference in pressure between the gases on the two sides of the membrane, or between the gas on one side of the membrane and the liquid on the other side of the membrane.

The magnitude of the pressure difference used to treat the membrane is dependent on the membrane being treated. The pressure difference may be a predetermined pressure difference, may be chosen based on a measurement made during the method, or may be chosen through iterative steps of treating the membrane to a pressure difference and testing the resulting membrane to measure one or more characteristics of the membrane, and repeating the treating and testing until the membrane has one or more desired characteristics.

Flux of the treated membrane, when it is used in membrane distillation, increases as the magnitude of the pressure difference increases since additional closed or semi-closed pores are being opened as the pressure difference increases. Once all the available closed or semi-closed pores are opened, the flux of the treated membrane does not increase with increased pressure difference. It is desirable to treat the membrane at the lowest pressure difference that provides the highest stable permeate flux. A stable permeate flux is the amount of permeate flux after the membrane distillation has reached a stable operating equilibrium, for example the amount of permeate flux after the membrane distillation has been operating for 10 hours, 20 hours, 30 hours, 40 hours, 50 hours, 60 hours, or longer. The maximum pressure difference which may be used to treat the membrane without rupturing the membrane is dependent on the membrane material and the pore size. The smaller the pore size, the greater the pressure difference the membrane is able to bear. In particular examples, for example using a GE Osmonics Corporation polypropylene membrane (Product Number 1211410), there is a pressure difference, which is, in an embodiment, greater than 1 psig, and in some examples is more particularly greater than 3 psig, and is less than about 28 psig. In an embodiment, the pressure difference is about 15 psig.

Predetermining the pressure difference to be used could be achieved, for example, by calculating the gas pressure required to blow out a closed pore of a given size. Alternatively, predetermining the pressure difference to be used could be achieved, for example, by referring to known or calculated gas pressures required to blow out a closed or semi-closed pore of a given size.

In an example of choosing the pressure difference based on a measurement from the method, the gas pressure on one side of the membrane could be increased until a desired gas flow rate or increase in gas flow rate across the membrane is observed.

An example of choosing the pressure difference though iterative steps could include:
treating the membrane to a first pressure difference,
testing the membrane to measure one or more characteristics of the membrane (for example, the effective porosity of the membrane),
treating the membrane to a second pressure difference which is greater than the first pressure difference if the measured characteristics did not meet a desired threshold,
testing the membrane to measure the one or more characteristics,
repeating the treating and testing until the measured characteristics meet a desired threshold.

The gases on the two sides of the membrane may be the same or different. The gases may be any gas which is non-reactive with the membrane. For example, the gas may be air, nitrogen, argon, helium, a non-polar gas, or any combination thereof. The gas, in an embodiment, is not an organic gas, such as methane or ethane. In particular examples, the gas is air. The liquid on one of the sides of the membrane may be liquid used during membrane distillation, for example, the permeate or the feed liquid.

A hydrophobic membrane may be a polyethylene (PE) membrane, polytetrafluoroethylene (PTFE) membrane, polypropylene (PP) membrane, poly(vinylidene fluoride) (PVDF) membrane, polyvinyl chloride (PVC), nylon, or any other hydrophobic polymer membrane that is able to prevent bulk liquid transport across the hydrophobic membrane while allowing transport of water vapour across the hydrophobic membrane. Hydrophobic membranes can, alternatively, be prepared from hydrophilic polymers which are transformed into hydrophobic membranes by, for example, radiation grafting polymerization or plasma polymerization. In particular examples, the hydrophobic membrane is a polypropylene (PP) membrane. One example of a PP membrane which may be used in the disclosed method is a membrane made by GE Osmonics Corporation (Product Number 1211410) which has a pore size of 0.1 microns, a thickness of 100 microns, a pore size distribution from 0.03 microns to 0.37 microns, and a porosity of about 70-75%. This commercially available membrane may be used for the filtration of liquid or gas dust in, for example, the separation of impurity in water and biological samples or the pretreatment of air gas before being used in a turbine.

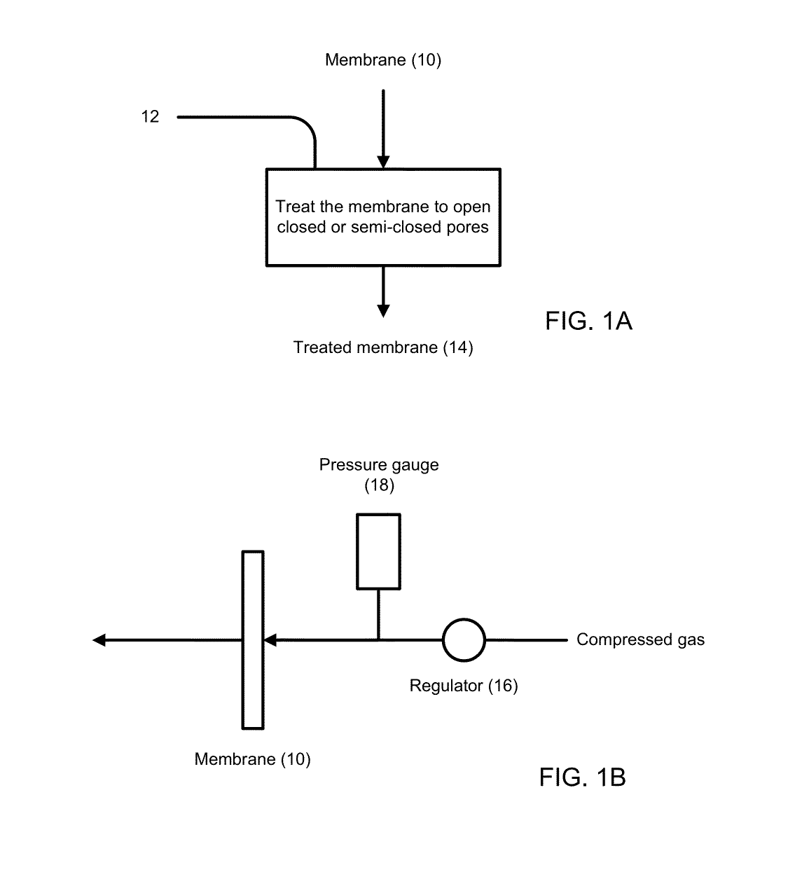

According to one example, illustrated in FIG. 1A, a newly manufactured membrane (10) is treated at 12 with a predetermined pressure difference across the membrane using pressurized air on one side of the membrane and air at atmospheric pressure on the other side of the membrane, resulting in a treated membrane (14).

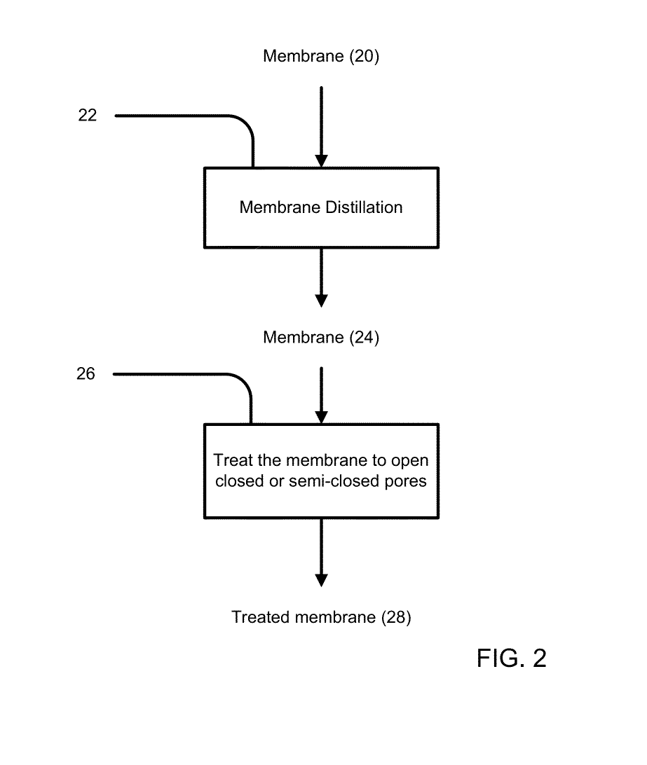

According to another example, illustrated in FIG. 2, a membrane (20) is provided which was not previously been treated to open closed pores. The membrane (20) is used in membrane distillation at 22, which results in a membrane (24) having closed pores. The membrane (24) is treated at 26 with a pressure difference across the membrane using pressurized air on the permeate side of the membrane and a liquid on the feed side of the membrane. The pressure difference is increased until the pressurized air flows across the membrane from the permeate side to the feed side. This results in treated membrane (28).

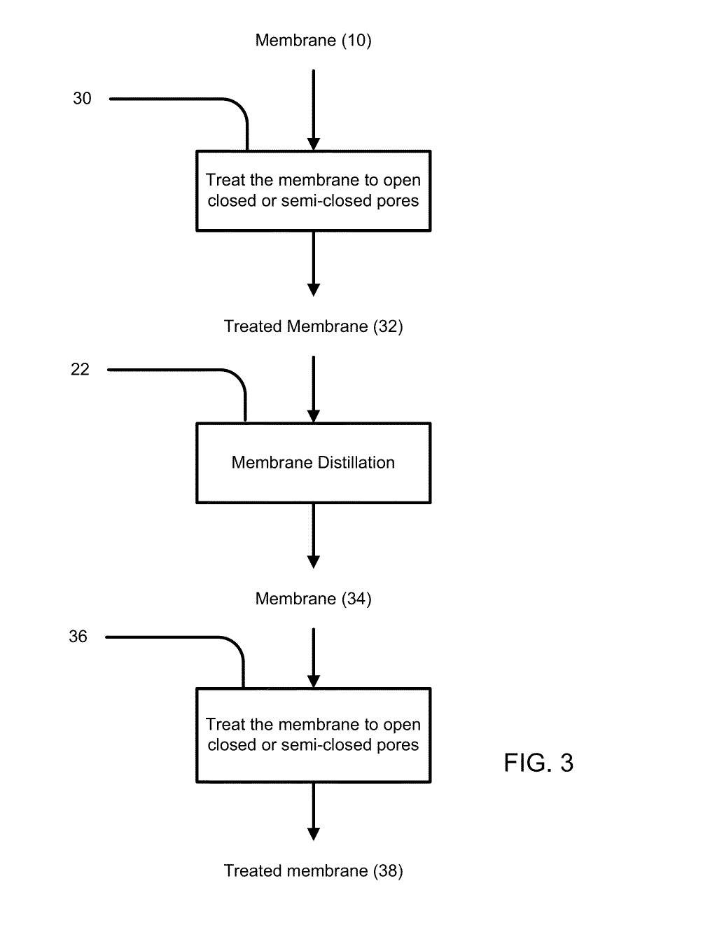

According to a further example, illustrated in FIG. 3, newly manufactured membrane (10) is treated at 30 with a pressure difference across the membrane using pressurized air on the permeate side of the membrane and air at a reduced pressure on the feed side of the membrane to generate treated membrane (32). Treated membrane (32) is used in membrane distillation at 22, which results in a membrane (34) having closed pores, semi-closed pores, or both. The membrane (34) is treated with a predetermined pressure difference across the membrane at 36 using air at atmospheric pressure on the permeate side of the membrane and air at a reduced pressure on the feed side of the membrane. This results in treated membrane (38).

In the methods of any of FIGS. 1 to 3, the membrane may be placed in a suitable fixture allowing the required fluid pressures to be applied to opposite sides of the membrane. One side of the membrane may be open to the atmosphere. Alternatively, the process steps may take place in a membrane distillation unit. For example, one or both sides of the membrane distillation may be drained and pressurized gas may be applied to a drained side.

In a specific embodiment, a treated hydrophobic membrane was produced according to the method illustrated in FIG. 1A. The method of FIG. 1A may be performed using, for example, an apparatus illustrated in FIG. 1B. Briefly, membrane (10) is subjected to a compressed gas at a pressure of about 0.20 to about 0.25 MPa. A regulator (16) may be used to adjust the pressure. The gas flow rate entering the membrane (10) may be further adjusted using a pressure control valve, not shown. A pressure gauge (18) may be used, for example, to read the pressure on the compressed-gas side of the membrane (10). The pressure on the compressed-gas side of the membrane approximates the trans-membrane pressure. A plurality of different gauges, for example a U-type monometer or a digital pressure meter, may be used to measure the pressure difference across the membrane since different gauges provide different measurement accuracies. The pressure drop across the membrane (10) may be measured directly using, for example, a digital pressure drop meter.

In operation, the compressed gas blows through the membrane and opens closed or semi-closed pores. The resulting treated membrane (14) was tested in a membrane distillation apparatus to evaluate the performance of the treated membrane (14). The membrane distillation was tested using a contaminated water source having 50 g NaCl per liter; a feed flow rate of 900 mL/min; a permeate flow rate of 500 mL/min, a contaminated water source temperature of 60° C. and a condensing surface temperature of 20° C.

The treated hydrophobic membrane may have over a 35% increase in permeate flux, a salt rejection of 99.98%, and a longer operational stability compared with the untreated membrane. Operational stability is reflected by the length of time that membrane distillation can be performed at a desired level of salt rejection, level of permeate flux or both.

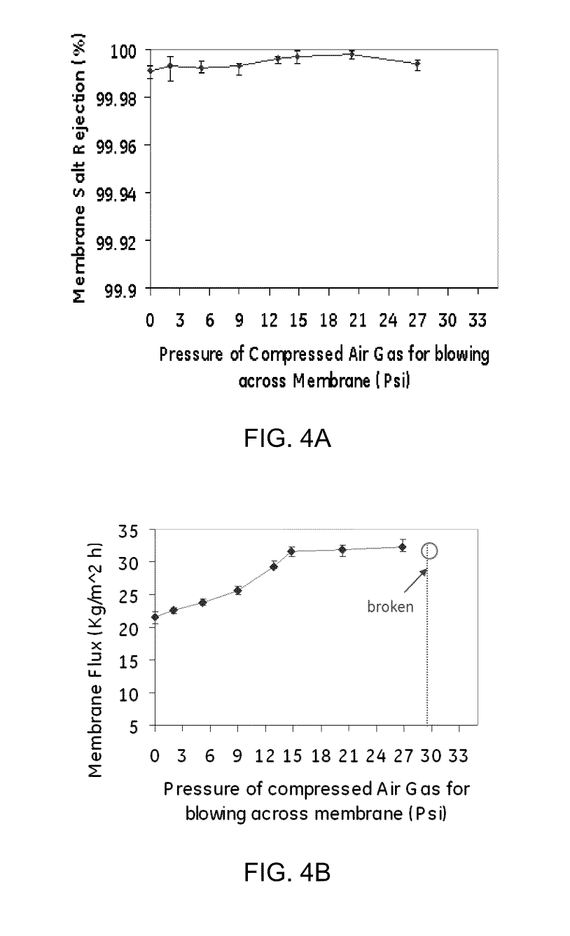

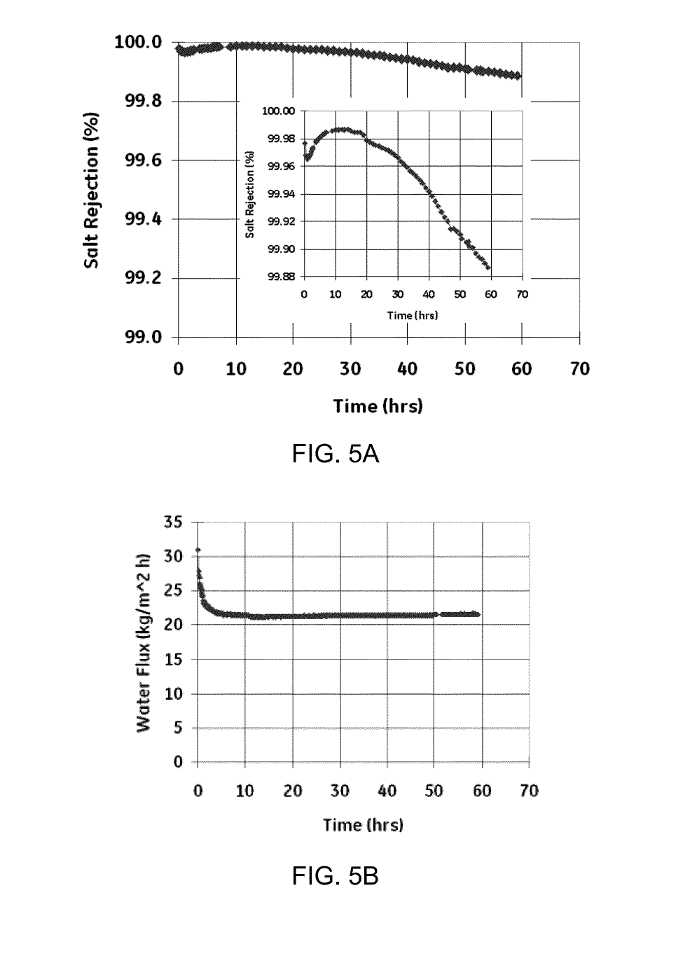

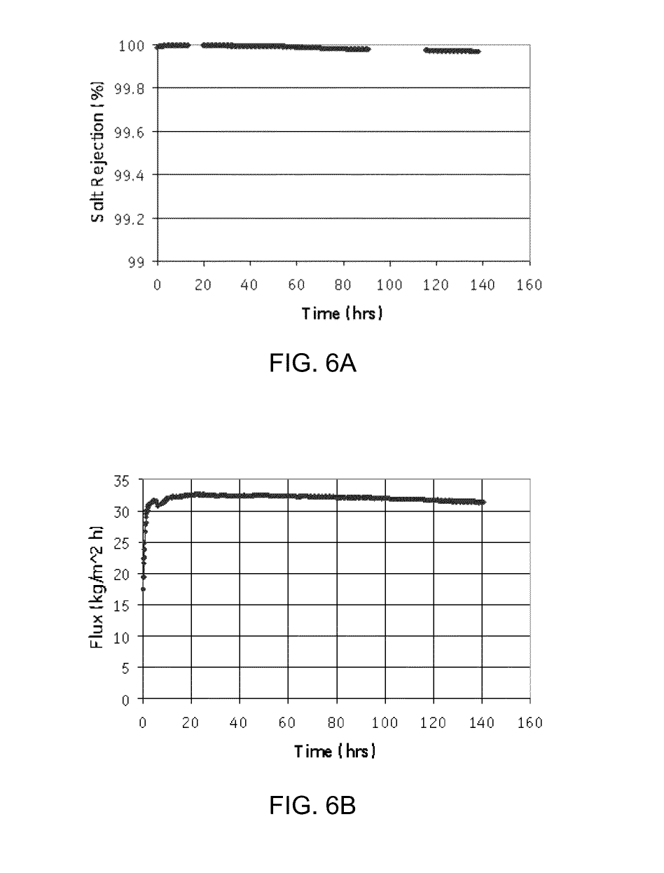

Different polypropylene hydrophobic membranes (GE Osmonics Corporation, Product Number 1211410) were treated with different pressure differences and the resulting treated hydrophobic membranes were tested in a membrane distillation apparatus to evaluate the performance of the treated membranes. The membrane distillation apparatus was operated using: a contaminated water source having 50 g NaCl per liter; a feed flow rate of 900 mL/min; a permeate flow rate of 500 mL/min, a contaminated water source temperature of 60° C. and a condensing surface temperature of 20° C. The performance of the treated hydrophobic membranes vs. untreated hydrophobic membrane is shown in FIGS. 4A and 4B, where FIG. 4A shows the salt rejection at different pressure differences and FIG. 4B shows the membrane flux at different pressure differences. A pressure difference of zero represents untreated membrane. The operational stability of the treated hydrophobic membrane vs. untreated hydrophobic membrane is shown in FIGS. 5A through 6A. In FIGS. 5A and 5B, the salt rejection and permeate flux are shown over time for an untreated membrane. In contrast, FIGS. 6A and 6B show the salt rejection and permeate flux over time for a membrane treated according to the present description at a pressure of 15.6 psig.

After 60 hours, the treated membrane shows a permeate flux of about 32 kg/m²*h (see FIG. 6B), while the untreated membrane shows a permeate flux of about 21 kg/m²*h (see FIG. 5B). This corresponds to an increase in permeate flux of about 50%. Similarly, after 60 hours, the treated membrane shows a salt rejection of about 99.98% (see FIG. 6A), while the untreated membrane shows a salt rejection of about 99.89% (see FIG. 5A).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for treating a membrane for use in a membrane distillation process, the method comprising:
treating the membrane to a pressure difference across the membrane to open semi-closed pores, closed pores, or both semi-closed and closed pores, in the membrane.

2. The method according to claim 1, wherein treating the membrane to a pressure difference across the membrane comprises removing liquid water or solids present in the semi-closed pores, the closed pores, or both the semi-closed and closed pores.

3. The method according to claim 1, wherein the membrane is a hydrophobic membrane, and treating the membrane to a pressure difference across the membrane comprises one of the followings: increasing porosity of the membrane, increasing hydrophobicity of the membrane, or increasing both porosity and hydrophobicity of the membrane.

4. The method according to claim 1, wherein the pressure difference across the membrane is a predetermined pressure difference, chosen based on a measurement obtained from the method, or chosen through iteratively treating the membrane with a pressure difference and testing the membrane to measure a characteristic of the membrane.

5. The method according to claim 1, wherein the pressure difference across the membrane is a pressure difference sufficient to remove liquid water or solids present in the semi-closed pores, the closed pores, or both the semi-closed and closed pores.

6. The method according to claim 1, wherein the membrane comprises a first side and an opposite second side, and the pressure difference across the membrane is generated using one of the following:
a pressurized gas on the first side of the membrane and a gas at atmospheric pressure on the second side of the membrane;
a gas at a reduced pressure on the first side of the membrane and a gas at atmospheric pressure on the second side of the membrane;
a pressurized gas on the first side of the membrane and a gas at a reduced pressure on the second side of the membrane; or
a pressurized gas on the first side of the membrane and a liquid on the second side of the membrane;
wherein the pressure difference across the membrane corresponds to the difference in pressure between the gases or liquids on the first and the second sides of the membrane.

7. The method according to claim 6, wherein the first side is a permeate side of the membrane, and the second side is a feed side of the membrane.

8. The method according to claim 6, wherein the first side is a feed side of the membrane, and the second side is side of the membrane.

9. The method according to claim 6, wherein the gases on the first and the second sides of the membrane are both air.

10. The method according to claim 1, wherein the membrane is a polyethylene (PE) membrane, polytetrafluoroethylene (PTFE) membrane, polypropylene (PP) membrane, poly(vinylidene fluoride) (PVDF) membrane, polyvinylchloride (PVC) membrane, or nylon membrane.

11. The method according to claim 1, wherein the membrane is a polypropylene membrane.

12. The method according to claim 1, wherein the membrane has a pore size of about 0.1 microns.

13. The method according to claim 1, wherein the membrane has a thickness of about 100 microns.

14. The method according to claim 1, further comprising using the membrane in a membrane distillation process.

15. The method according to claim 14, wherein the membrane is used in the membrane distillation process before the membrane is treated to the pressure difference across the membrane.

16. The membrane according to claim 14, wherein the membrane is treated to the pressure difference across the membrane before the membrane is used in the membrane distillation process.

17. The method according to claim 16, further comprising treating the membrane to a pressure difference across the membrane to open semi-closed pores, closed pores, or both semi-closed and closed pores, in the membrane after the membrane is used in the membrane distillation process.

18. A membrane for use in a membrane distillation process, the membrane having been treated with a pressure difference across the membrane to open semi-closed pores, closed pores, or both semi-closed and closed pores, in the membrane.

19. The membrane according to claim 18, wherein the membrane treated with a pressure difference across the membrane has a stable permeate flux at least 35% greater than the stable permeate flux of the untreated membrane.

20. The membrane according to claim 18, wherein the membrane treated with a pressure difference across the membrane has a salt rejection of greater than 99.98% after 60 hours of membrane distillation.
